(19) United States
(12) Patent Application Publication
(10) Pub. No.: US 2026/0075623 A1
(43) Pub. Date: Mar. 12, 2026

(54) ABSOLUTE TIME DISTRIBUTION OVER SIDELINK COMMUNICATION

(71) Applicant: QUALCOMM INCORPORATED, San Diego, CA (US)

(72) Inventors: Dan Vassilovski, Del Mar, CA (US); Gabi Sarkis, San Diego, CA (US); Karthika Paladugu, Hyderabad (IN); Fatih Ulupinar, San Diego, CA (US); Ozcan Ozturk, San Diego, CA (US); Peng Cheng, Beijing (CN); Hong Cheng, Basking Ridge, NJ (US); Qing Li, Princeton Junction, NJ (US); Tien Viet Nguyen, Bridgewater, NJ (US); Gene Wesley Marsh, San Diego, CA (US); Gavin Bernard Horn, La Jolla, CA (US)

(21) Appl. No.: 18/870,003

(22) PCT Filed: Jul. 25, 2022
(86) PCT No.: PCT/CN2022/107584

§ 371 Date: Nov. 27, 2024

(51) Int. Cl. H04W 72/25; H04W 72/0446

(52) U.S. Cl. CPC H04W 72/25; H04W 72/0446

(57) ABSTRACT

Methods, systems, and devices for wireless communications are described. A wireless communications system may establish sidelink messages and information elements (IEs) that may be used to distribute absolute time information from a first user equipment (UE) to a second UE. Participating UEs (e.g., the first UE or the second UE) may be mobile or stationary (e.g., a roadside unit (RSU) ). The first UE may provide an absolute time to the second UE with ten nanosecond resolution, and the absolute time may be referenced to a global standard (e.g., universal time coordinated (UTC) time or global positioning system (GPS) time). Time messages may be exchanged (e.g., between the leapSeconds first UE and the second UE) using PC5 radio resource control (RRC) signaling or medium access control (MAC) control elements (MAC-CEs). Time distribution may be based on a request-response signaling or unilaterally provided by a participating UE (e.g., the first UE).

### CROSS REFERENCE

The present Application is a 371 national stage filing of International PCT Application No. PCT/CN2022/107584 by Vassilovski et al. entitled “ABSOLUTE TIME DISTRIBUTION OVER SIDELINK COMMUNICATION,” filed Jul. 25, 2022, which is assigned to the assignee hereof, and which is expressly incorporated by reference in its entirety herein.

### FIELD OF TECHNOLOGY

The following relates to wireless communications, including absolute time distribution over sidelink communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Some wireless communications systems may support sidelink communications between UEs. In such systems, it may be appropriate for a UE to identify an absolute time to use in various applications or for communications with other UEs or network entities. Improved techniques for distributing absolute time information in a wireless communications system supporting sidelink communications may be desirable.

### SUMMARY

The described techniques relate to improved methods, systems, devices, and apparatuses that support absolute time distribution over sidelink communication. A wireless communications system may establish sidelink messages and information elements (IEs) that may be used to distribute absolute time information from a first user equipment (UE) to at least a second UE (e.g., the second UE and zero or more other UEs). Participating UEs (e.g., the first UE or the second UE) may be mobile or stationary (e.g., a roadside unit (RSU)). The first UE may provide an absolute time to the second UE, and the absolute time may be referenced to a global standard (e.g., universal time coordinated (UTC) time or global positioning system (GPS) time). Time messages may be exchanged (e.g., between the first UE and the second UE) using PC5 radio resource control (RRC) signaling or medium access control (MAC) control elements (MAC-CEs). Time distribution may be based on a request-response signaling or unilaterally provided by a participating UE (e.g., the first UE).

A method for wireless communication at a first UE is described. The method may include receiving, from a second UE, a sidelink message including time information indicating an absolute time value referenced to a calendar date, where the sidelink message is received according to a set of multiple time intervals established for communication between the first UE and the second UE, setting, based on the absolute time value, an absolute time clock at a boundary of a reference time interval of the set of multiple time intervals, and communicating in accordance with the absolute time clock.

An apparatus for wireless communication at a first UE is described. The apparatus may include a processor, memory coupled with the processor, and instructions stored in the memory. The instructions may be executable by the processor to cause the apparatus to receive, from a second UE, a sidelink message including time information indicating an absolute time value referenced to a calendar date, where the sidelink message is received according to a set of multiple time intervals established for communication between the first UE and the second UE, set, based on the absolute time value, an absolute time clock at a boundary of a reference time interval of the set of multiple time intervals, and communicate in accordance with the absolute time clock.

Another apparatus for wireless communication at a first UE is described. The apparatus may include means for receiving, from a second UE, a sidelink message including time information indicating an absolute time value referenced to a calendar date, where the sidelink message is received according to a set of multiple time intervals established for communication between the first UE and the second UE, means for setting, based on the absolute time value, an absolute time clock at a boundary of a reference time interval of the set of multiple time intervals, and means for communicating in accordance with the absolute time clock.

A non-transitory computer-readable medium storing code for wireless communication at a first UE is described. The code may include instructions executable by a processor to receive, from a second UE, a sidelink message including time information indicating an absolute time value referenced to a calendar date, where the sidelink message is received according to a set of multiple time intervals established for communication between the first UE and the second UE, set, based on the absolute time value, an absolute time clock at a boundary of a reference time interval of the set of multiple time intervals, and communicate in accordance with the absolute time clock.

Some examples of the method, apparatuses, and non-transitory computer-readable medium described herein may further include operations, features, means, or instructions for transmitting, to the second UE, a request for the time information, where the sidelink message including the time information may be received from the second UE in response to transmitting the request.

In some examples of the method, apparatuses, and non-transitory computer-readable medium described herein, the boundary of the reference time interval may be at a beginning of the reference time interval, the reference time interval immediately after a time interval in which the sidelink message may be received.

Some examples of the method, apparatuses, and non-transitory computer-readable medium described herein may further include operations, features, means, or instructions for receiving, in the time information of the sidelink message, an indicator of the reference time interval.

In some examples of the method, apparatuses, and non-transitory computer-readable medium described herein, the indicator of the reference time interval includes a distributed frame number.

In some examples of the method, apparatuses, and non-transitory computer-readable medium described herein, the sidelink message includes a first field including the absolute time value and a second field including the indicator of the reference time interval, and the second field includes a third field indicating additional reference time information.

In some examples of the method, apparatuses, and non-transitory computer-readable medium described herein, the sidelink message includes a first field including the absolute time value and the indicator of the reference time interval, and the sidelink message includes a second field indicating additional reference time information.

In some examples of the method, apparatuses, and non-transitory computer-readable medium described herein, the time information indicates a type of the absolute time value, the type of the absolute time value corresponding to either universal time coordinated time, global positioning system time, or local clock time.

In some examples of the method, apparatuses, and non-transitory computer-readable medium described herein, receiving the sidelink message including the time information may include operations, features, means, or instructions for receiving, from the second UE in a broadcast or groupcast transmission, a medium access control (MAC) control element (MAC-CE) including the time information.

Some examples of the method, apparatuses, and non-transitory computer-readable medium described herein may further include operations, features, means, or instructions for communicating with the second UE or a third UE for timing synchronization, where the reference time interval includes a frame with boundaries determined based on communicating with the second UE or the third UE for timing synchronization.

In some examples of the method, apparatuses, and non-transitory computer-readable medium described herein, the first UE may be outside a coverage area of any network entity, and the second UE may be within a coverage area of at least one network entity.

A method for wireless communication at a first UE is described. The method may include receiving a message including first time information indicating a first absolute time value, where the first absolute time value is reference to a calendar date, setting an absolute time clock at a first boundary of a first reference time interval based on the first absolute time value, determining a second absolute time value at a second boundary of a second reference time interval based on the absolute time clock, where the second reference time interval is one of a set of multiple time intervals established for communication between the first UE and a second UE, and transmitting, to the second UE, a sidelink message including second time information indicating the second absolute time value.

An apparatus for wireless communication at a first UE is described. The apparatus may include a processor, memory coupled with the processor, and instructions stored in the memory. The instructions may be executable by the processor to cause the apparatus to receive a message including first time information indicating a first absolute time value, where the first absolute time value is reference to a calendar date, set an absolute time clock at a first boundary of a first reference time interval based on the first absolute time value, determine a second absolute time value at a second boundary of a second reference time interval based on the absolute time clock, where the second reference time interval is one of a set of multiple time intervals established for communication between the first UE and a second UE, and transmit, to the second UE, a sidelink message including second time information indicating the second absolute time value.

Another apparatus for wireless communication at a first UE is described. The apparatus may include means for receiving a message including first time information indicating a first absolute time value, where the first absolute time value is reference to a calendar date, means for setting an absolute time clock at a first boundary of a first reference time interval based on the first absolute time value, means for determining a second absolute time value at a second boundary of a second reference time interval based on the absolute time clock, where the second reference time interval is one of a set of multiple time intervals established for communication between the first UE and a second UE, and means for transmitting, to the second UE, a sidelink message including second time information indicating the second absolute time value.

A non-transitory computer-readable medium storing code for wireless communication at a first UE is described. The code may include instructions executable by a processor to receive a message including first time information indicating a first absolute time value, where the first absolute time value is reference to a calendar date, set an absolute time clock at a first boundary of a first reference time interval based on the first absolute time value, determine a second absolute time value at a second boundary of a second reference time interval based on the absolute time clock, where the second reference time interval is one of a set of multiple time intervals established for communication between the first UE and a second UE, and transmit, to the second UE, a sidelink message including second time information indicating the second absolute time value.

Some examples of the method, apparatuses, and non-transitory computer-readable medium described herein may further include operations, features, means, or instructions for receiving, from the second UE, a request for the second time information, where the sidelink message including the second time information may be transmitted to the second UE in response to receiving the request.

In some examples of the method, apparatuses, and non-transitory computer-readable medium described herein, receiving the message including the first time information may include operations, features, means, or instructions for receiving, from a network entity, a downlink message including the first time information indicating the first absolute time value.

In some examples of the method, apparatuses, and non-transitory computer-readable medium described herein, the first reference time interval may be indicated by a system frame number in the first time information.

In some examples of the method, apparatuses, and non-transitory computer-readable medium described herein, receiving the message including the first time information may include operations, features, means, or instructions for receiving, from a third UE, a second sidelink message including the first time information indicating the first absolute time value.

In some examples of the method, apparatuses, and non-transitory computer-readable medium described herein, the first reference time interval may be indicated by a distributed frame number in the first time information.

In some examples of the method, apparatuses, and non-transitory computer-readable medium described herein, the second boundary of the second reference time interval may be at a beginning of the second reference time interval, the second reference time interval immediately after a time interval in which the sidelink message may be transmitted.

Some examples of the method, apparatuses, and non-transitory computer-readable medium described herein may further include operations, features, means, or instructions for transmitting, in the second time information of the sidelink message, an indicator of the second reference time interval.

In some examples of the method, apparatuses, and non-transitory computer-readable medium described herein, the indicator of the second reference time interval includes a distributed frame number.

In some examples of the method, apparatuses, and non-transitory computer-readable medium described herein, the sidelink message includes a first field including the second absolute time value and a second field including the indicator of the second reference time interval, and the second field includes a third field indicating additional reference time information.

In some examples of the method, apparatuses, and non-transitory computer-readable medium described herein, first sidelink message includes a first field including the second absolute time value and the indicator of the second reference time interval, and the sidelink message includes a second field indicating additional reference time information.

In some examples of the method, apparatuses, and non-transitory computer-readable medium described herein, the second time information indicates a type of the second absolute time value, the type of the second absolute time value corresponding to either universal time coordinated time, global positioning system time, or local clock time.

In some examples of the method, apparatuses, and non-transitory computer-readable medium described herein, transmitting the sidelink message including the second time information may include operations, features, means, or instructions for transmitting, in a broadcast or groupcast transmission, a medium access control (MAC) control element (MAC-CE) including the second time information.

Some examples of the method, apparatuses, and non-transitory computer-readable medium described herein may further include operations, features, means, or instructions for communicating with a third UE or a network entity for timing synchronization, where boundaries for the first reference time interval and the second reference time interval may be determined based on communicating with the third UE or the network entity for timing synchronization.

In some examples of the method, apparatuses, and non-transitory computer-readable medium described herein, the first UE may be within a coverage area of at least one network entity, and the second UE may be outside a coverage area of any network entity.

### BRIEF DESCRIPTION OF THE DRAWINGS

FIG. 1 illustrates an example of a wireless communications system that supports absolute time distribution over sidelink communication in accordance with one or more aspects of the present disclosure.

FIG. 2 illustrates an example of a wireless communications system that supports absolute time distribution over sidelink communication in accordance with one or more aspects of the present disclosure.

FIG. 3 illustrates an example of absolute time distribution over sidelink communication in accordance with one or more aspects of the present disclosure.

FIG. 4 illustrates an example of a medium access control (MAC) control element (MAC-CE) for distributing time information over sidelink communication in accordance with one or more aspects of the present disclosure.

FIG. 5 illustrates an example of a process flow that supports absolute time distribution over sidelink communication in accordance with one or more aspects of the present disclosure.

FIGS. 6 and 7 show block diagrams of devices that support absolute time distribution over sidelink communication in accordance with one or more aspects of the present disclosure.

FIG. 8 shows a block diagram of a communications manager that supports absolute time distribution over sidelink communication in accordance with one or more aspects of the present disclosure.

FIG. 9 shows a diagram of a system including a device that supports absolute time distribution over sidelink communication in accordance with one or more aspects of the present disclosure.

FIGS. 10 and 11 show flowcharts illustrating methods that support absolute time distribution over sidelink communication in accordance with one or more aspects of the present disclosure.

### DETAILED DESCRIPTION

Some wireless communications systems may support sidelink communications between user equipments (UEs). In such systems, it may be appropriate for a UE to identify an absolute time to use in various applications or for communications with other UEs or network entities. For instance, having accurate time information (e.g., nanosecond or ten nanosecond resolution) may be useful for many aspects of UE operation such as coordinated action or communication. Some mechanisms may be defined for a network to inform a UE of an absolute time (e.g., a universal time coordinated (UTC) time or global positioning system (GPS) time) over a Uu connection using common system information signaling or dedicated signaling. In some cases, however, for UEs supporting sidelink communications that are outside of a coverage area of a network, no such signaling of an absolute time may be defined. That is, techniques for signaling an absolute time to a UE without a Uu connection may be undefined, and the functionality of the UE may be limited.

The described techniques provide for efficiently distributing absolute time information in a wireless communications system supporting sidelink communications. The wireless communications system may establish sidelink messages and IEs that may be used to distribute absolute time information from a first UE to a second UE.

Participating UEs (e.g., the first UE or the second UE) may be mobile or stationary (e.g., a roadside unit (RSU)). The first UE may provide an absolute time to the second UE, and the absolute time may be referenced to a global standard (e.g., UTC time or GPS time). The absolute time may have nanosecond or ten nanosecond resolution). Time messages may be exchanged (e.g., between the first UE and the second UE) using PC5 radio resource control (RRC) signaling or medium access control (MAC) control elements (MAC-CEs). Time distribution may be based on a request-response signaling or unilaterally provided by a participating UE (e.g., the first UE).

Aspects of the disclosure are initially described in the context of wireless communications systems. Aspects of the disclosure are further illustrated by and described with reference to apparatus diagrams, system diagrams, and flowcharts that relate to absolute time distribution over sidelink communication.

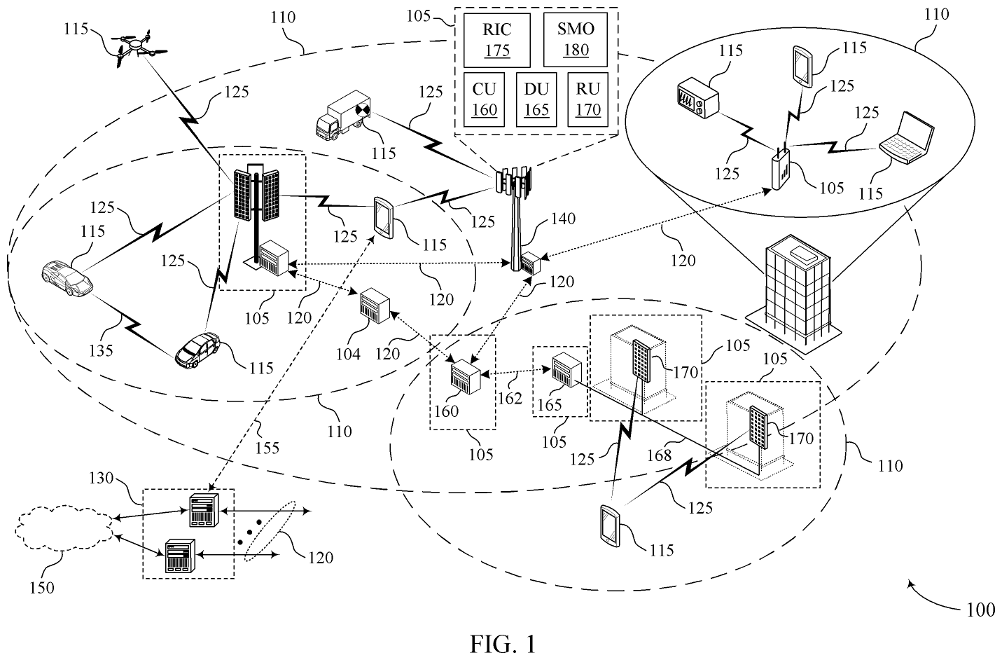

FIG. 1 illustrates an example of a wireless communications system 100 that supports absolute time distribution over sidelink communication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support absolute time distribution over sidelink communication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δθₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As mentioned above, UEs 115 may communicate with each other over a D2D communication link 135. The D2D communication link 135 may be referred to as a sidelink. In some cases, sidelink communications may include communications over one or more sidelink channels. For instance, sidelink data transmissions may be over a physical sidelink shared channel (PSSCH), sidelink discovery expression transmissions may be over a physical sidelink discovery channel (PSDCH) (e.g., to allow proximal devices to discover each other's presence), sidelink control information transmissions may be over a physical sidelink control channel (PSCCH), sidelink feedback transmissions may be over a physical sidelink feedback channel (PSFCH), and sidelink broadcast transmissions may be over a physical sidelink broadcast channel (PSBCH). Sidelink communications may also include transmitting reference signals from one UE 115 to another UE 115.

Sidelink communications may take place in transmission or reception resource pools. A minimum resource allocation unit for sidelink communications may be a sub-channel in a frequency domain, and a resource allocation in a time domain for sidelink communications may be one slot. Some slots may not be available for sidelink, and some slots may contain feedback resources. In some cases, a sidelink transmission from one UE 115 to another UE 115 may be a transmission on sidelink resources that the other UE 115 may monitor for the sidelink transmission. In some aspects, an RRC configuration for sidelink communications may be preconfigured (e.g., preloaded on a UE 115) or signaled to a UE 115 (e.g., from a base station 105). In some examples, a network entity 105 facilitates the scheduling of resources for sidelink communications (e.g., in a resource allocation mode 1). In other cases, sidelink communications are carried out between the UEs 115 without the involvement of a network entity 105 (e.g., in a resource allocation mode 2).

In wireless communications system 100, it may be appropriate for a UE 115 to identify an absolute time to use in various applications or for communications with other UEs 115 or network entities 105. For instance, having accurate time information may be useful for many aspects of UE sidelink operation. Some mechanisms (e.g., in LTE or NR) may be defined for a network to inform a UE 115 of an absolute time (e.g., a UTC time or GPS time) over a Uu connection using common system information signaling (e.g., a system information block (SIB) 9 (SIB9)) or dedicated signaling (e.g., in a DLInformationTransfer IE). In some cases, however, for UEs 115 supporting sidelink communications (e.g., V2X or industrial IoT (IiOT) devices) that are outside of a coverage area of a network, no such signaling of an absolute time may be defined. That is, techniques for signaling an absolute time to a UE 115 without a Uu connection may be undefined, and the functionality of the UE 115 may be limited.

The wireless communications system 100 may support efficient techniques for distributing absolute time information to UEs 115 supporting sidelink communications. The wireless communications system 100 may establish sidelink messages and IEs that may be used to distribute absolute time information from a first UE 115 to a second UE 115 (e.g., messages and IEs used in over-the-air (OTA) sidelink communication for dissemination of absolute time information). Participating UEs 115 (e.g., the first UE 115 or the second UE 115) may be mobile or stationary (e.g., a roadside unit (RSU)). The first UE 115 may provide an absolute time to the second UE 115, and the absolute time may be referenced to a global standard (e.g., UTC time or GPS time). Time messages may be exchanged (e.g., between the first UE 115 and the second UE 115) using PC5-RRC signaling or MAC-CEs. Time distribution may be based on a request-response signaling or unilaterally provided by a participating UE 115 (e.g., the first UE 115).

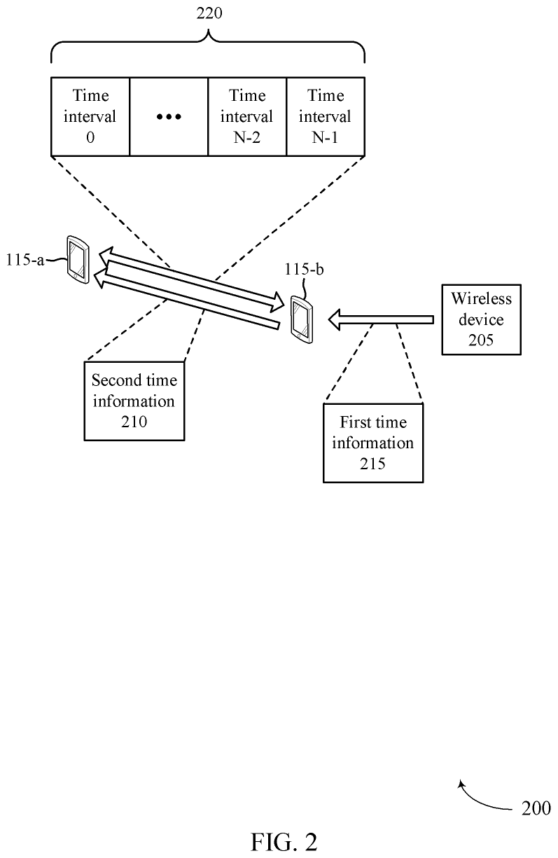

FIG. 2 illustrates an example of a wireless communications system 200 that supports absolute time distribution over sidelink communication in accordance with one or more aspects of the present disclosure. The wireless communications system 200 includes a UE 115-a and a UE 115-b, which may be examples of UEs 115 described with reference to FIG. 1. The wireless communications system 200 also includes a wireless device 205, which may be an example of a UE 115 or a network entity 105 described with reference to FIG. 1. The wireless communications system 200 may implement aspects of the wireless communications system 100. For example, the wireless communications system 200 may support efficient techniques for distributing absolute time information to UEs 115 supporting sidelink communications.

The UE 115-b may receive first time information 215 from the wireless device 205 indicating a first absolute time value referenced to a calendar date. The UE 115-b may then set an absolute time clock at a boundary of a first reference time interval based on the first absolute time value. The boundary of the first reference time interval may correspond to an end of a time interval in which the first time information 215 is received or a beginning of a time interval following the time interval in which the first time information 215 is received. The first reference time interval may be one of multiple time intervals established for communications at the UE 115-b. For instance, if the wireless device 205 is a network entity, the first reference time interval may be one of multiple system frames established for communications with the network entity 105. Alternatively, if the wireless device 205 is a UE 115, the first reference time interval may be one of multiple distributed frames established for communications with the UE 115. In any case, the UE 115-b may identify the first absolute time value at the boundary of the first reference time interval and may keep track of an absolute time.

Because the UE 115-b may keep track of an absolute time, the UE 115-b may be capable of sharing or distributing the absolute time to other UEs 115. For instance, the UE 115-b may transmit, and the UE 115-a may receive, second time information indicating a second absolute time value (e.g., a time value referenced to global standard time). The UE 115-a may then set an absolute time clock at a boundary of a second reference time interval based on the second absolute time value. The second reference time interval may be one of multiple time intervals 220 established for communications at the UE 115-a. For instance, the UE 115-a may communicate with the UE 115-b to establish the time intervals 220 for communicating with the UE 115-b, or the UE 115-a may otherwise identify the time intervals 220. Thus, the UE 115-b may identify the second absolute time value at the boundary of the second reference time interval and may keep track of an absolute time. That is, the UE 115-b may distribute absolute time information (e.g., the second time information including the second absolute time value) over sidelink to the UE 115-a.

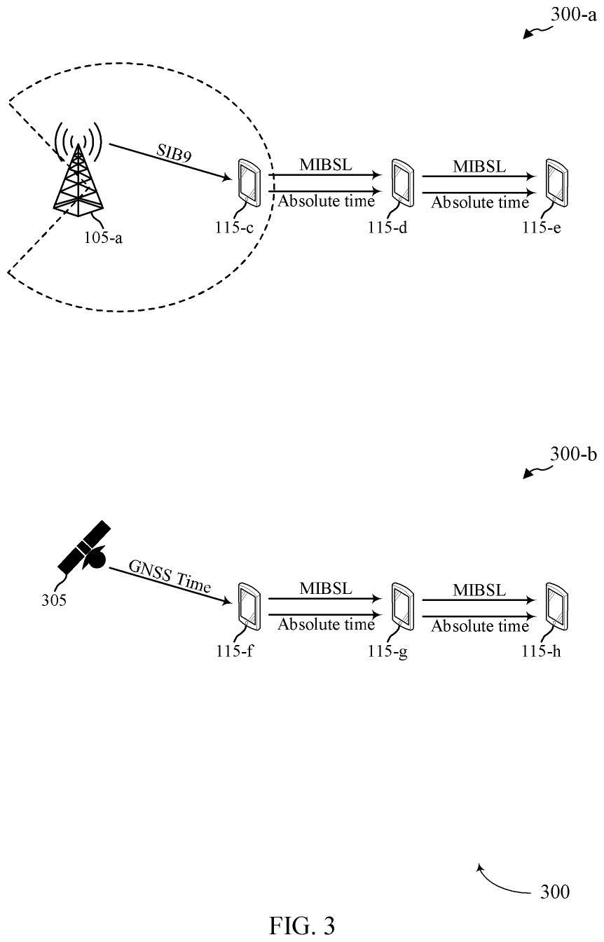

FIG. 3 illustrates an example of absolute time distribution 300 over sidelink communication in accordance with one or more aspects of the present disclosure.

In a first example 300-a, the UE 115-c may be within a coverage area of the network entity 105-a, and the UE 115-d and the UE 115-e may be outside a coverage area of any network entity 105. The network entity 105-a may transmit, and the UE 115-c, may receive a SIB9 message indicating absolute time information (e.g., absolute time to UE 115-c via SIB9). The absolute time information may indicate a first absolute time value at a boundary of a first reference time interval, where the first reference time interval is one of multiple first time intervals established for communications between the network entity 105-a and the UE 115-c. The UE 115-c may transmit a master information block sidelink (MIBSL) to the UE 115-d indicating or identifying multiple second time intervals for communications between the UE 115-c and the UE 115-d (e.g., for synchronization to the UE 115-d via the MIBSL). The UE 115-c may then transmit, and the UE 115-d may receive, a sidelink message indicating a second absolute time value (e.g., absolute (UTC, GPS) time transmitted over sidelink to UE 115-d) at a boundary of a second reference time interval, where the second reference time interval is one of the multiple second time intervals established for communications between the UE 115-c and the UE 115-d. Similarly, the UE 115-d may transmit a MIBSL to the UE 115-e indicating or identifying multiple third time intervals for communications between the UE 115-d and the UE 115-e (e.g., for synchronization to the UE 115-e via the MIBSL). The UE 115-d may then transmit, and the UE 115-e may receive, a sidelink message indicating a third absolute time value (e.g., absolute (UTC, GPS) time transmitted over sidelink to UE 115-e) at a boundary of a third reference time interval, where the third reference time interval is one of the multiple third time intervals established for communications between the UE 115-d and the UE 115-e.

In a second example 300-b, the UE 115-f, the UE 115-g, and the UE 115-h may each be outside a coverage area of any network entity 105. The global navigation satellite system (GNSS) 305 may transmit, and the UE 115-f, may receive a message indicating absolute time information (e.g., GNSS time). The absolute time information may indicate a first absolute time value and ephemeris data of one or more of the GNSS transmitters. The UE 115-f may calculate an absolute time at the UE 115-f using the absolute time information and the ephemeris data. The UE 115-f may transmit a MIBSL to the UE 115-g indicating or identifying multiple first time intervals for communications between the UE 115-f and the UE 115-g (e.g., for synchronization to the UE 115-g via the MIBSL). The UE 115-f may then transmit, and the UE 115-g may receive, a sidelink message indicating a second absolute time value at a boundary of a first reference time interval (e.g., absolute (UTC, GPS) time transmitted over sidelink to UE 115-g), where the first reference time interval is one of the multiple first time intervals established for communications between the UE 115-f and the UE 115-g. Similarly, the UE 115-g may transmit a MIBSL to the UE 115-h indicating or identifying multiple second time intervals for communications between the UE 115-g and the UE 115-h (e.g., for synchronization to the UE 115-h via the MIBSL). The UE 115-g may then transmit, and the UE 115-h may receive, a sidelink message indicating a third absolute time value at a boundary of a second reference time interval (e.g., absolute (UTC, GPS) time transmitted over sidelink to UE 115-h), where the second reference time interval is one of the multiple second time intervals established for communications between the UE 115-g and the UE 115-h.

The described techniques may support various messages or IEs for distributing absolute time information (e.g., the second time information 210) over sidelink. In one aspect, absolute time information may be distributed in a PC5-RRC message. In some examples, the PC5-RRC message may include an indication of absolute time referenced to a distributed frame number (DFN), and the PC5-RRC message may be similar to a SIB9 message (e.g., include similar fields to the SIB9 message). If the PC5-RRC message is similar to the SIB9 message, there may be minimal changes at the UE 115-a to receive the PC5-RRC message. In other examples, the PC5-RRC message may be simplified (e.g., with less nesting than the SIB9 message) and may include a single IE to indicate an absolute time (e.g., UTC time or GPS time) referenced to a DFN. If the PC5-RRC message is simplified, the overhead of the PC5-RRC message and the complexity of parsing the PC5-RRC message may be minimized. In another aspect, absolute time information may be distributed in a MAC-CE (e.g., groupcast or broadcast to multiple UEs 115).

The PC5-RRC message similar to the SIB9 message may include a first field including an absolute time value and a second field including an indicator of a reference time interval, and the second field may include a third field indicating additional reference time information. For instance, the PC5-RRC message may include an SL-TimeInformation IE, and the SL-TimeInformation IE may include an sl-timeInfo IE (e.g., a first field) and an sl-referenceTimeInfo IE (e.g., a second field). The sl-timeInfo IE (e.g., the first field) may include a SidelinkTimeInfoUTC IE indicating a UTC time corresponding to a DFN boundary at or immediately after the DFN in which the SL-TimeInformation IE is transmitted (or received). The SidelinkTimeInfoUTC IE or field may count the number of UTC seconds in 10 ms units since 00:00:00 on a Gregorian calendar date of 1 Jan. 1900 (e.g., midnight between Sunday, Dec. 31, 1899 and Monday, Jan. 1, 1900). The sl-referenceTimeInfo IE (e.g., the second field) may include an sl-referenceDFN IE indicating a reference DFN corresponding to the reference time information. The sl-referenceTimeInfo IE may also include a time field including additional reference time information. For instance, the time field may reference an SL-ReferenceTime IE (e.g., third field) indicating a time reference with 10 ns granularity. If the sl-reference TimeInfo field is received in SL-TimeInfoUTC, the time field may indicate the time at a DFN boundary at or immediately after the ending boundary of a DFN in which the SL-TimeInfoUTC is transmitted (or received). If the sl-reference TimeInfo field is received in SL-TimeInfoUTC, the sl-referenceTimeInfo field may be excluded when determining changes in system information (e.g., changes of time may neither result in system information change notifications nor in a modification of valueTag in SIB1). The SL-ReferenceTime IE may also include a refSource field indicate a time source used for the reference time.

The simplified PC5-RRC message (e.g., with less nesting than the SIB9 message) may include a first field including the absolute time value and an indicator of the reference time interval and a second field indicating additional reference time information. For instance, the PC5-RRC message may include an SL-ReferenceTimeInformation IE (e.g., first field), and the SL-ReferenceTimeInformation IE may include a time field and an sl-referenceDFN field. The time field may reference an SL-ReferenceTime IE (e.g., second field) indicating a time reference with 10 ns granularity, and the sl-referenceDFN field may indicate a reference DFN corresponding to the reference time information. If the sl-referenceTimeInfo field is received in SL-TimeInfoUTC, the time field may indicate the time at a DFN boundary at or immediately after the ending boundary of a DFN in which the SL-TimeInfoUTC is transmitted (or received). If the sl-referenceTimeInfo field is received in SL-TimeInfoUTC, the sl-referenceTimeInfo field may be excluded when determining changes in system information (e.g., changes of time may neither result in system information change notifications nor in a modification of valueTag in SIB1). The SL-ReferenceTimeInformation IE may also include a timeInfoType IE that may indicate whether an absolute time provided is GPS time, UTC time, or unspecified (e.g., a local clock). The SL-ReferenceTime IE referenced by the time field and indicating the time reference with 10 ns granularity may include a refDays field, a refSeconds field, a refMilliSeconds field, a refTenNanoSeconds field, a dayLightSavingTime field, a leapSeconds field, and a localTimeOffset field.

In some cases, the described techniques may also support a PC5-RRC time distribution request message that a UE 115 may use to request absolute time information. For instance, the UE 115-a may explicitly request absolute time information from the UE 115-b. In one example, the request may be based on an SL-ReferenceTimeInfo IE. In this example, the UE 115-a may transmit an SL-ReferenceTimeRequest IE including an sl-timeInfo field that requests an SL-TimeInfo IE, and the UE 115-a may receive a message with the SL-TimeInfo IE in response to transmitting the SL-ReferenceTimeRequest IE. In another example, the request may be based on an SL-ReferenceTimeInformation IE. In this example, the UE 115-a may transmit an SL-ReferenceTimeRequest IE including an sl-ReferenceTimeInformation field requesting an SL-ReferenceTimeInformation IE, and the UE 115-a may receive a message with the SL-ReferenceTimeInformation IE in response to transmitting the SL-Reference TimeRequest IE.

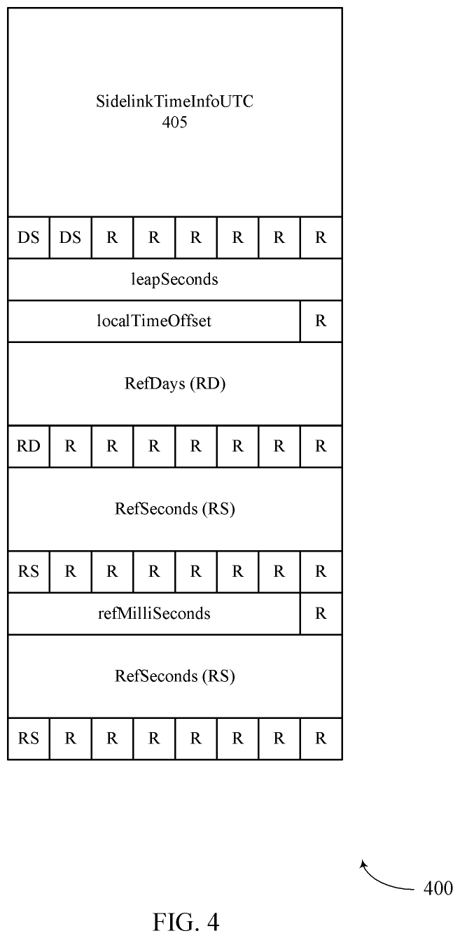

FIG. 4 illustrates an example of a MAC-CE 400 for distributing time information over sidelink communication in accordance with one or more aspects of the present disclosure. A UE 115 may groupcast or broadcast the MAC-CE 400 to multiple UEs 115 and may include absolute time information for each of the multiple UEs. The MAC-CE 400 may include a SidelinkTimeInfoUTC IE 405 indicating a UTC time corresponding to a DFN boundary at or immediately after the DFN in which the MAC-CE 400 is transmitted (or received). The SidelinkTimeInfoUTC IE or field may count the number of UTC seconds in 10 ms units since 00:00:00 on a Gregorian calendar date of 1 Jan. 1900 (e.g., midnight between Sunday, Dec. 31, 1899 and Monday, Jan. 1, 1900). The MAC-CE 400 may also include a leapSeconds field, a localTimeOffset field, a refDays field, a refSeconds field, a refMilliSeconds field, and another refSeconds field or a refTenNanoSeconds field.

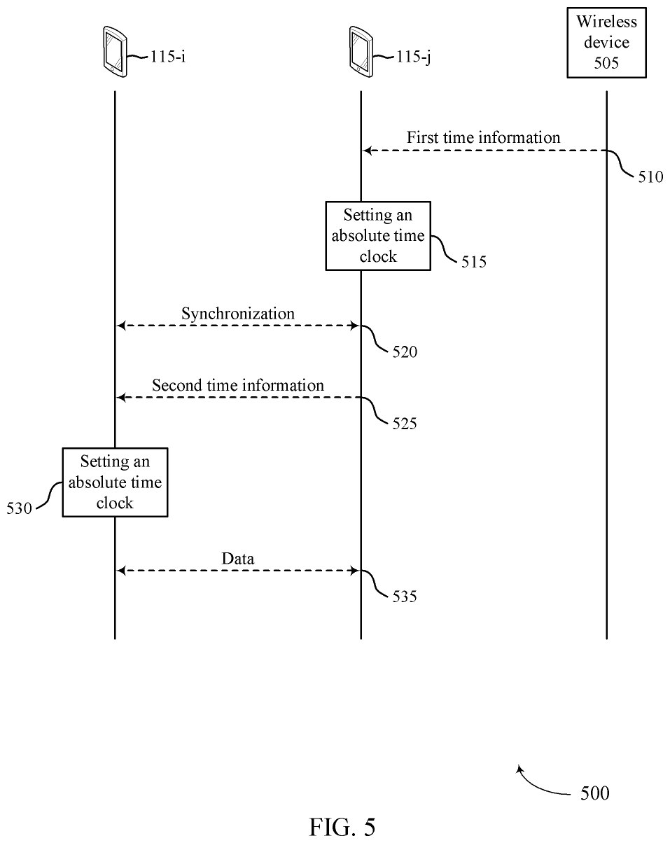

FIG. 5 illustrates an example of a process flow 500 that supports absolute time distribution over sidelink communication in accordance with one or more aspects of the present disclosure. The process flow 500 includes a UE 115-i and a UE 115-j, which may be examples of UEs 115 described with reference to FIGS. 1-4. The process flow 500 also includes a wireless device 505, which may be an example of a UE 115, a network entity 105, or a corresponding device described with reference to FIGS. 1-4. The process flow 500 may implement aspects of the wireless communications system 100 or the wireless communications system 200. For example, the process flow 500 may support efficient techniques for distributing absolute time information to UEs 115 supporting sidelink communications.

In the following description of the process flow 500, the signaling exchanged between the UE 115-i, the UE 115-j, and the wireless device 505 may be exchanged in a different order than the example order shown, or the operations performed by the UE 115-i, the UE 115-j, and the wireless device 505 may be performed in different orders or at different times. Some operations may also be omitted from the process flow 500, and other operations may be added to the process flow 500.

At 510, the wireless device 505 may transmit, and the UE 115-j may receive, a message including first time information indicating a first absolute time value. The first absolute time value may be referenced to a calendar date, a global standard, or both.

At 515, the UE 115-j may set an absolute time clock at a first boundary of a first reference time interval based on the first absolute time value. If the wireless device 505 is a network entity 105, the message including the time information may be a downlink message, the first reference time interval may be a system frame, and the first reference time interval may be indicated by an SFN in the first time information. If the wireless device 505 is a UE 115, the message including the time information may be a sidelink message, the first reference time interval may be a distributed frame, and the first reference time interval may be indicated by a DFN in the first time information.

At 520, the UE 115-i and the UE 115-j may communicate with each other for timing synchronization. For instance, the UE 115-i and the UE 115-j may communicate to establish time intervals (e.g., a start time of the time intervals, indices of the time intervals, and a duration of each time interval) for communications between the UE 115-i and the UE 115-j. In some examples, the UE 115-i may communicate with another UE 115 for timing synchronization (e.g., to establish time intervals for communications at the UE 115-i). In some examples, timing synchronization information (e.g., to establish time intervals for communications) may be broadcast or groupcast to multiple UEs including the UE 115-i.

The UE 115-j may determine a second absolute time value at a second boundary of a second reference time interval based on the absolute time clock at the UE 115-j. The second absolute time value may be referenced to a calendar date, a global standard, or both. The second reference time interval may be one of the time intervals established for communication between the UE 115-i and the UE 115-j or established for communication at the UE 115-i.

At 525, the UE 115-j may transmit, and the UE 115-i may receive, a sidelink message (e.g., a PC5-RRC message or MAC-CE) including second time information indicating the second absolute time value. In some examples, the UE 115-i may transmit, and the UE 115-j may receive, a request for the second time information, and the UE 115-i may receive, and the UE 115-j may transmit, the sidelink message including the second time information in response to the request. In some examples, the sidelink message includes a first field including the second absolute time value and a second field including the indicator of the second reference time interval, and the second field includes a third field indicating additional reference time information. In some examples, the sidelink message includes a first field including the second absolute time value and the indicator of the second reference time interval, and the sidelink message includes a second field indicating additional reference time information. The second time information may indicate a type of the second absolute time value, the type of the second absolute time value corresponding to either UTC time, GPS time, or local clock time.

At 530, the UE 115-i may set an absolute time clock at a boundary of the second reference time interval based on the absolute time value. In some examples, the boundary of the second reference time interval may be at a beginning of the second reference time interval, and the second reference time interval may be immediately after (e.g., subsequent and adjacent to) a time interval in which the second sidelink message is received or transmitted. In some examples, the UE 115-j may transmit, and the UE 115-i, may receive, in the second time information of the sidelink message, an indicator of the second reference time interval. The reference time interval may be a distributed frame, and the indicator of the reference time interval may be a DFN.

At 535, the UE 115-i may communicate (e.g., exchanged data) with the UE 115-j or other UEs 115 in accordance with the absolute time clock. For instance, an accurate, absolute time may be useful for IiOT applications or automotive V2X communication.

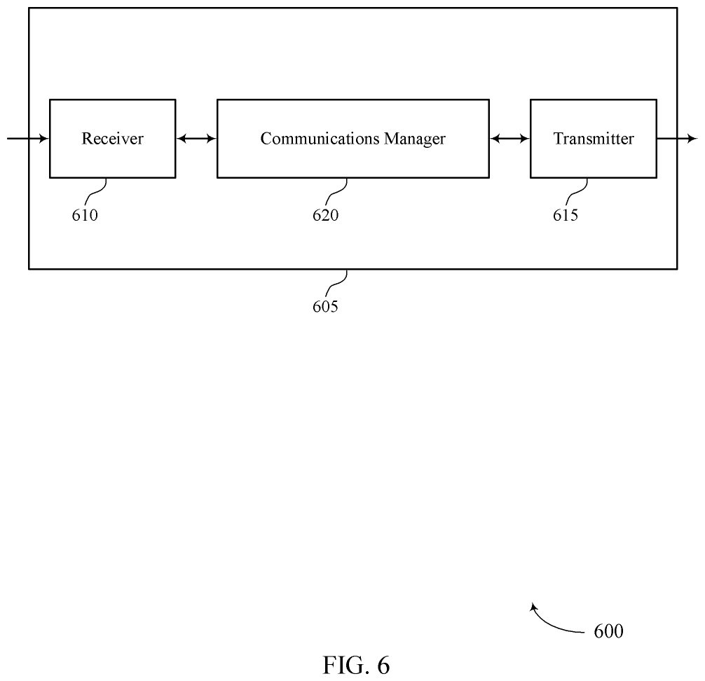

FIG. 6 shows a block diagram 600 of a device 605 that supports absolute time distribution over sidelink communication in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to absolute time distribution over sidelink communication). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to absolute time distribution over sidelink communication). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of absolute time distribution over sidelink communication as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first UE in accordance with examples as disclosed herein. For example, the communications manager 620 may be configured as or otherwise support a means for receiving, from a second UE, a sidelink message including time information indicating an absolute time value referenced to a calendar date, where the sidelink message is received according to a set of multiple time intervals established for communication between the first UE and the second UE. The communications manager 620 may be configured as or otherwise support a means for setting, based on the absolute time value, an absolute time clock at a boundary of a reference time interval of the set of multiple time intervals. The communications manager 620 may be configured as or otherwise support a means for communicating in accordance with the absolute time clock.

Additionally, or alternatively, the communications manager 620 may support wireless communication at a first UE in accordance with examples as disclosed herein. For example, the communications manager 620 may be configured as or otherwise support a means for receiving a message including first time information indicating a first absolute time value, where the first absolute time value is reference to a calendar date. The communications manager 620 may be configured as or otherwise support a means for setting an absolute time clock at a first boundary of a first reference time interval based on the first absolute time value. The communications manager 620 may be configured as or otherwise support a means for determining a second absolute time value at a second boundary of a second reference time interval based on the absolute time clock, where the second reference time interval is one of a set of multiple time intervals established for communication between the first UE and a second UE. The communications manager 620 may be configured as or otherwise support a means for transmitting, to the second UE, a sidelink message including second time information indicating the second absolute time value.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, or more efficient utilization of communication resources. Because the described techniques may provide for distributing absolute time information over sidelink communications, the device 605 may be able to identify an absolute time and use the absolute time in various applications (e.g., IiOT applications) or sidelink communications (e.g., V2X communications). As a result, the efficiency of these applications or sidelink communications may be improved, resulting in the reduced processing, reduced power consumption, or more efficient utilization of communication resources.

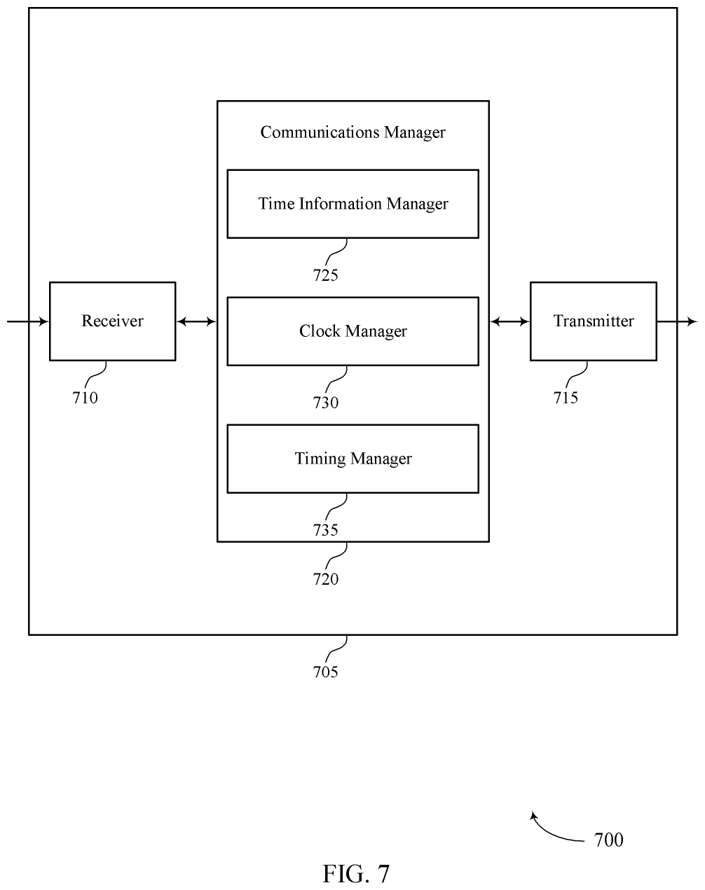

FIG. 7 shows a block diagram 700 of a device 705 that supports absolute time distribution over sidelink communication in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to absolute time distribution over sidelink communication). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to absolute time distribution over sidelink communication). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of absolute time distribution over sidelink communication as described herein. For example, the communications manager 720 may include a time information manager 725, a clock manager 730, a timing manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. The time information manager 725 may be configured as or otherwise support a means for receiving, from a second UE, a sidelink message including time information indicating an absolute time value referenced to a calendar date, where the sidelink message is received according to a set of multiple time intervals established for communication between the first UE and the second UE. The clock manager 730 may be configured as or otherwise support a means for setting, based on the absolute time value, an absolute time clock at a boundary of a reference time interval of the set of multiple time intervals. The timing manager 735 may be configured as or otherwise support a means for communicating in accordance with the absolute time clock.

Additionally, or alternatively, the communications manager 720 may support wireless communication at a first UE in accordance with examples as disclosed herein. The time information manager 725 may be configured as or otherwise support a means for receiving a message including first time information indicating a first absolute time value, where the first absolute time value is reference to a calendar date. The clock manager 730 may be configured as or otherwise support a means for setting an absolute time clock at a first boundary of a first reference time interval based on the first absolute time value. The time information manager 725 may be configured as or otherwise support a means for determining a second absolute time value at a second boundary of a second reference time interval based on the absolute time clock, where the second reference time interval is one of a set of multiple time intervals established for communication between the first UE and a second UE. The time information manager 725 may be configured as or otherwise support a means for transmitting, to the second UE, a sidelink message including second time information indicating the second absolute time value.

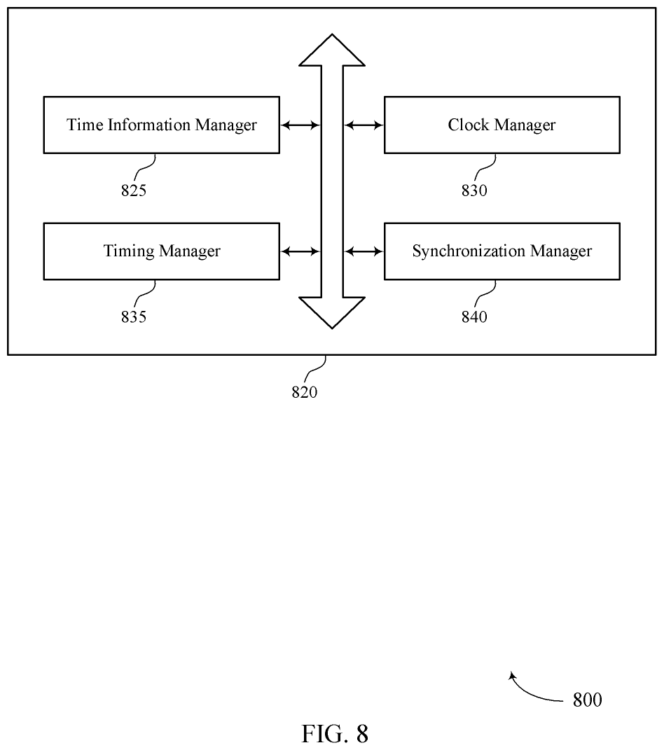

FIG. 8 shows a block diagram 800 of a communications manager 820 that supports absolute time distribution over sidelink communication in accordance with one or more aspects of the present disclosure. The communications manager 820 may be an example of aspects of a communications manager 620, a communications manager 720, or both, as described herein. The communications manager 820, or various components thereof, may be an example of means for performing various aspects of absolute time distribution over sidelink communication as described herein. For example, the communications manager 820 may include a time information manager 825, a clock manager 830, a timing manager 835, a synchronization manager 840, or any combination thereof. Each of these components may communicate, directly or indirectly, with one another (e.g., via one or more buses).

The communications manager 820 may support wireless communication at a first UE in accordance with examples as disclosed herein. The time information manager 825 may be configured as or otherwise support a means for receiving, from a second UE, a sidelink message including time information indicating an absolute time value referenced to a calendar date, where the sidelink message is received according to a set of multiple time intervals established for communication between the first UE and the second UE. The clock manager 830 may be configured as or otherwise support a means for setting, based on the absolute time value, an absolute time clock at a boundary of a reference time interval of the set of multiple time intervals. The timing manager 835 may be configured as or otherwise support a means for communicating in accordance with the absolute time clock.

In some examples, the time information manager 825 may be configured as or otherwise support a means for transmitting, to the second UE, a request for the time information, where the sidelink message including the time information is received from the second UE in response to transmitting the request.

In some examples, the boundary of the reference time interval is at a beginning of the reference time interval, the reference time interval immediately after a time interval in which the sidelink message is received.

In some examples, the time information manager 825 may be configured as or otherwise support a means for receiving, in the time information of the sidelink message, an indicator of the reference time interval.

In some examples, the indicator of the reference time interval includes a distributed frame number.

In some examples, the sidelink message includes a first field including the absolute time value and a second field including the indicator of the reference time interval, and the second field includes a third field indicating additional reference time information.

In some examples, the sidelink message includes a first field including the absolute time value and the indicator of the reference time interval, and the sidelink message includes a second field indicating additional reference time information.

In some examples, the time information indicates a type of the absolute time value, the type of the absolute time value corresponding to either universal time coordinated time, global positioning system time, or local clock time.

In some examples, to support receiving the sidelink message including the time information, the time information manager 825 may be configured as or otherwise support a means for receiving, from the second UE in a broadcast or groupcast transmission, a medium access control (MAC) control element (MAC-CE) including the time information.

In some examples, the synchronization manager 840 may be configured as or otherwise support a means for communicating with the second UE or a third UE for timing synchronization, where the reference time interval includes a frame with boundaries determined based on communicating with the second UE or the third UE for timing synchronization.

In some examples, the first UE is outside a coverage area of any network entity, and the second UE is within a coverage area of at least one network entity.

Additionally, or alternatively, the communications manager 820 may support wireless communication at a first UE in accordance with examples as disclosed herein. In some examples, the time information manager 825 may be configured as or otherwise support a means for receiving a message including first time information indicating a first absolute time value, where the first absolute time value is reference to a calendar date. In some examples, the clock manager 830 may be configured as or otherwise support a means for setting an absolute time clock at a first boundary of a first reference time interval based on the first absolute time value. In some examples, the time information manager 825 may be configured as or otherwise support a means for determining a second absolute time value at a second boundary of a second reference time interval based on the absolute time clock, where the second reference time interval is one of a set of multiple time intervals established for communication between the first UE and a second UE. In some examples, the time information manager 825 may be configured as or otherwise support a means for transmitting, to the second UE, a sidelink message including second time information indicating the second absolute time value.

In some examples, the time information manager 825 may be configured as or otherwise support a means for receiving, from the second UE, a request for the second time information, where the sidelink message including the second time information is transmitted to the second UE in response to receiving the request.

In some examples, to support receiving the message including the first time information, the time information manager 825 may be configured as or otherwise support a means for receiving, from a network entity, a downlink message including the first time information indicating the first absolute time value.

In some examples, the first reference time interval is indicated by a system frame number in the first time information.

In some examples, to support receiving the message including the first time information, the time information manager 825 may be configured as or otherwise support a means for receiving, from a third UE, a second sidelink message including the first time information indicating the first absolute time value.

In some examples, the first reference time interval is indicated by a distributed frame number in the first time information.

In some examples, the second boundary of the second reference time interval is at a beginning of the second reference time interval, the second reference time interval immediately after a time interval in which the sidelink message is transmitted.

In some examples, the time information manager 825 may be configured as or otherwise support a means for transmitting, in the second time information of the sidelink message, an indicator of the second reference time interval.

In some examples, the indicator of the second reference time interval includes a distributed frame number.

In some examples, the sidelink message includes a first field including the second absolute time value and a second field including the indicator of the second reference time interval, and the second field includes a third field indicating additional reference time information.

In some examples, first sidelink message includes a first field including the second absolute time value and the indicator of the second reference time interval, and the sidelink message includes a second field indicating additional reference time information.

In some examples, the second time information indicates a type of the second absolute time value, the type of the second absolute time value corresponding to either universal time coordinated time, global positioning system time, or local clock time.

In some examples, to support transmitting the sidelink message including the second time information, the time information manager 825 may be configured as or otherwise support a means for transmitting, in a broadcast or groupcast transmission, a medium access control (MAC) control element (MAC-CE) including the second time information.

In some examples, the synchronization manager 840 may be configured as or otherwise support a means for communicating with a third UE or a network entity for timing synchronization, where boundaries for the first reference time interval and the second reference time interval are determined based on communicating with the third UE or the network entity for timing synchronization.

In some examples, the first UE is within a coverage area of at least one network entity, and the second UE is outside a coverage area of any network entity.

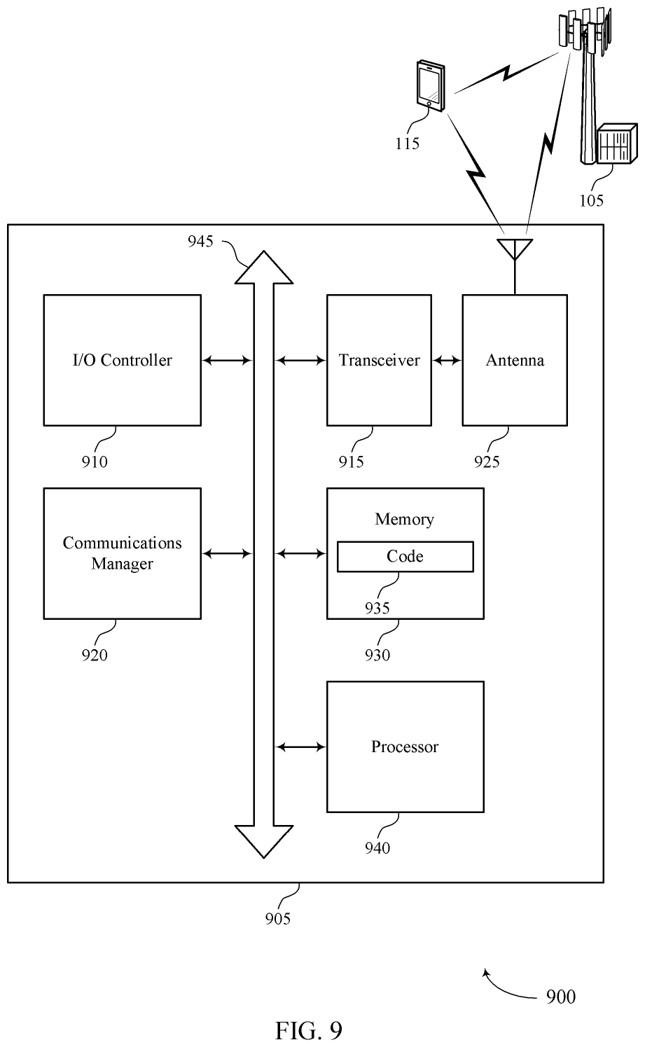

FIG. 9 shows a diagram of a system 900 including a device 905 that supports absolute time distribution over sidelink communication in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting absolute time distribution over sidelink communication). For example, the device 905 or a component of the device 905 may include a processor 940 and memory 930 coupled with or to the processor 940, the processor 940 and memory 930 configured to perform various functions described herein.

The communications manager 920 may support wireless communication at a first UE in accordance with examples as disclosed herein. For example, the communications manager 920 may be configured as or otherwise support a means for receiving, from a second UE, a sidelink message including time information indicating an absolute time value referenced to a calendar date, where the sidelink message is received according to a set of multiple time intervals established for communication between the first UE and the second UE. The communications manager 920 may be configured as or otherwise support a means for setting, based on the absolute time value, an absolute time clock at a boundary of a reference time interval of the set of multiple time intervals. The communications manager 920 may be configured as or otherwise support a means for communicating in accordance with the absolute time clock.

Additionally, or alternatively, the communications manager 920 may support wireless communication at a first UE in accordance with examples as disclosed herein. For example, the communications manager 920 may be configured as or otherwise support a means for receiving a message including first time information indicating a first absolute time value, where the first absolute time value is reference to a calendar date. The communications manager 920 may be configured as or otherwise support a means for setting an absolute time clock at a first boundary of a first reference time interval based on the first absolute time value. The communications manager 920 may be configured as or otherwise support a means for determining a second absolute time value at a second boundary of a second reference time interval based on the absolute time clock, where the second reference time interval is one of a set of multiple time intervals established for communication between the first UE and a second UE. The communications manager 920 may be configured as or otherwise support a means for transmitting, to the second UE, a sidelink message including second time information indicating the second absolute time value.

By including or configuring the communications manager 920 in accordance with examples as described herein, the device 905 may support techniques for reduced processing, reduced power consumption, or more efficient utilization of communication resources. Because the described techniques may provide for distributing absolute time information over sidelink communications, the device 905 may be able to identify an absolute time and use the absolute time in various applications (e.g., IiOT applications) or sidelink communications (e.g., V2X communications). As a result, the efficiency of these applications or sidelink communications may be improved, resulting in the reduced processing, reduced power consumption, or more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of absolute time distribution over sidelink communication as described herein, or the processor 940 and the memory 930 may be otherwise configured to perform or support such operations.

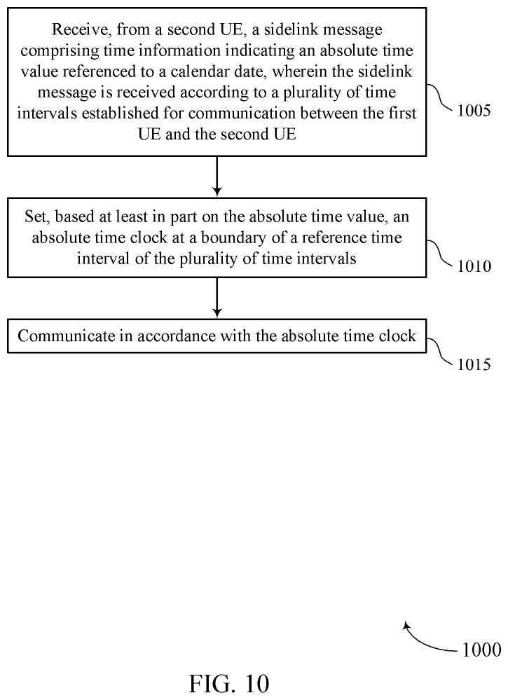

FIG. 10 shows a flowchart illustrating a method 1000 that supports absolute time distribution over sidelink communication in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving, from a second UE, a sidelink message including time information indicating an absolute time value referenced to a calendar date, where the sidelink message is received according to a set of multiple time intervals established for communication between the first UE and the second UE. The operations of 1005 may be performed in accordance with examples as disclosed herein. In some examples, aspects of the operations of 1005 may be performed by a time information manager 825 as described with reference to FIG. 8.

At 1010, the method may include setting, based on the absolute time value, an absolute time clock at a boundary of a reference time interval of the set of multiple time intervals. The operations of 1010 may be performed in accordance with examples as disclosed herein. In some examples, aspects of the operations of 1010 may be performed by a clock manager 830 as described with reference to FIG. 8.

At 1015, the method may include communicating in accordance with the absolute time clock. The operations of 1015 may be performed in accordance with examples as disclosed herein. In some examples, aspects of the operations of 1015 may be performed by a timing manager 835 as described with reference to FIG. 8.

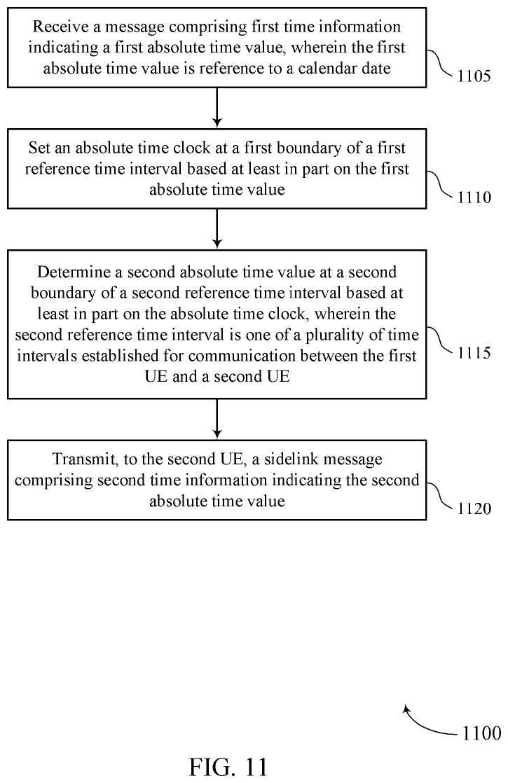

FIG. 11 shows a flowchart illustrating a method 1100 that supports absolute time distribution over sidelink communication in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving a message including first time information indicating a first absolute time value, where the first absolute time value is reference to a calendar date. The operations of 1105 may be performed in accordance with examples as disclosed herein. In some examples, aspects of the operations of 1105 may be performed by a time information manager 825 as described with reference to FIG. 8.

At 1110, the method may include setting an absolute time clock at a first boundary of a first reference time interval based on the first absolute time value. The operations of 1110 may be performed in accordance with examples as disclosed herein. In some examples, aspects of the operations of 1110 may be performed by a clock manager 830 as described with reference to FIG. 8.

At 1115, the method may include determining a second absolute time value at a second boundary of a second reference time interval based on the absolute time clock, where the second reference time interval is one of a set of multiple time intervals established for communication between the first UE and a second UE. The operations of 1115 may be performed in accordance with examples as disclosed herein. In some examples, aspects of the operations of 1115 may be performed by a time information manager 825 as described with reference to FIG. 8.

At 1120, the method may include transmitting, to the second UE, a sidelink message including second time information indicating the second absolute time value. The operations of 1120 may be performed in accordance with examples as disclosed herein. In some examples, aspects of the operations of 1120 may be performed by a time information manager 825 as described with reference to FIG. 8.

The following provides an overview of aspects of the present disclosure:

Aspect 1: A method for wireless communication at a first UE, comprising: receiving, from a second UE, a sidelink message comprising time information indicating an absolute time value referenced to a calendar date, wherein the sidelink message is received according to a plurality of time intervals established for communication between the first UE and the second UE; setting, based at least in part on the absolute time value, an absolute time clock at a boundary of a reference time interval of the plurality of time intervals; and communicating in accordance with the absolute time clock.

Aspect 2: The method of aspect 1, further comprising: transmitting, to the second UE, a request for the time information, wherein the sidelink message comprising the time information is received from the second UE in response to transmitting the request.

Aspect 3: The method of any of aspects 1 through 2, wherein the boundary of the reference time interval is at a beginning of the reference time interval, the reference time interval immediately after a time interval in which the sidelink message is received.

Aspect 4: The method of any of aspects 1 through 3, further comprising: receiving, in the time information of the sidelink message, an indicator of the reference time interval.

Aspect 5: The method of aspect 4, wherein the indicator of the reference time interval comprises a distributed frame number.

Aspect 6: The method of any of aspects 4 through 5, wherein the sidelink message comprises a first field comprising the absolute time value and a second field comprising the indicator of the reference time interval, and the second field comprises a third field indicating additional reference time information.

Aspect 7: The method of any of aspects 4 through 6, wherein the sidelink message comprises a first field comprising the absolute time value and the indicator of the reference time interval, and the sidelink message comprises a second field indicating additional reference time information.

Aspect 8: The method of any of aspects 1 through 7, wherein the time information indicates a type of the absolute time value, the type of the absolute time value corresponding to either universal time coordinated time, global positioning system time, or local clock time.

Aspect 9: The method of any of aspects 1 through 8, wherein receiving the sidelink message comprising the time information comprises: receiving, from the second UE in a broadcast or groupcast transmission, a medium access control (MAC) control element (MAC-CE) comprising the time information.

Aspect 10: The method of any of aspects 1 through 9, further comprising: communicating with the second UE or a third UE for timing synchronization, wherein the reference time interval comprises a frame with boundaries determined based at least in part on communicating with the second UE or the third UE for timing synchronization.

Aspect 11: The method of any of aspects 1 through 10, wherein the first UE is outside a coverage area of any network entity, and the second UE is within a coverage area of at least one network entity.

Aspect 12: A method for wireless communication at a first UE, comprising: receiving a message comprising first time information indicating a first absolute time value, wherein the first absolute time value is reference to a calendar date; setting an absolute time clock at a first boundary of a first reference time interval based at least in part on the first absolute time value; determining a second absolute time value at a second boundary of a second reference time interval based at least in part on the absolute time clock, wherein the second reference time interval is one of a plurality of time intervals established for communication between the first UE and a second UE; and transmitting, to the second UE, a sidelink message comprising second time information indicating the second absolute time value.

Aspect 13: The method of aspect 12, further comprising: receiving, from the second UE, a request for the second time information, wherein the sidelink message comprising the second time information is transmitted to the second UE in response to receiving the request.

Aspect 14: The method of any of aspects 12 through 13, wherein receiving the message comprising the first time information comprises: receiving, from a network entity, a downlink message comprising the first time information indicating the first absolute time value.

Aspect 15: The method of aspect 14, wherein the first reference time interval is indicated by a system frame number in the first time information.

Aspect 16: The method of any of aspects 12 through 15, wherein receiving the message comprising the first time information comprises: receiving, from a third UE, a second sidelink message comprising the first time information indicating the first absolute time value.

Aspect 17: The method of aspect 16, wherein the first reference time interval is indicated by a distributed frame number in the first time information.

Aspect 18: The method of any of aspects 12 through 17, wherein the second boundary of the second reference time interval is at a beginning of the second reference time interval, the second reference time interval immediately after a time interval in which the sidelink message is transmitted.

Aspect 19: The method of any of aspects 12 through 18, further comprising: transmitting, in the second time information of the sidelink message, an indicator of the second reference time interval.

Aspect 20: The method of aspect 19, wherein the indicator of the second reference time interval comprises a distributed frame number.

Aspect 21: The method of any of aspects 19 through 20, wherein the sidelink message comprises a first field comprising the second absolute time value and a second field comprising the indicator of the second reference time interval, and the second field comprises a third field indicating additional reference time information.

Aspect 22: The method of any of aspects 19 through 21, wherein first sidelink message comprises a first field comprising the second absolute time value and the indicator of the second reference time interval, and the sidelink message comprises a second field indicating additional reference time information.

Aspect 23: The method of any of aspects 12 through 22, wherein the second time information indicates a type of the second absolute time value, the type of the second absolute time value corresponding to either universal time coordinated time, global positioning system time, or local clock time.

Aspect 24: The method of any of aspects 12 through 23, wherein transmitting the sidelink message comprising the second time information comprises: transmitting, in a broadcast or groupcast transmission, a medium access control (MAC) control element (MAC-CE) comprising the second time information.

Aspect 25: The method of any of aspects 12 through 24, further comprising: communicating with a third UE or a network entity for timing synchronization, wherein boundaries for the first reference time interval and the second reference time interval are determined based on communicating with the third UE or the network entity for timing synchronization.

Aspect 26: The method of any of aspects 12 through 25, wherein the first UE is within a coverage area of at least one network entity, and the second UE is outside a coverage area of any network entity.

Aspect 27: An apparatus for wireless communication at a first UE, comprising a processor; memory coupled with the processor; and instructions stored in the memory and executable by the processor to cause the apparatus to perform a method of any of aspects 1 through 11.

Aspect 28: An apparatus for wireless communication at a first UE, comprising at least one means for performing a method of any of aspects 1 through 11.

Aspect 29: A non-transitory computer-readable medium storing code for wireless communication at a first UE, the code comprising instructions executable by a processor to perform a method of any of aspects 1 through 11.

Aspect 30: An apparatus for wireless communication at a first UE, comprising a processor; memory coupled with the processor; and instructions stored in the memory and executable by the processor to cause the apparatus to perform a method of any of aspects 12 through 26.

Aspect 31: An apparatus for wireless communication at a first UE, comprising at least one means for performing a method of any of aspects 12 through 26.

Aspect 32: A non-transitory computer-readable medium storing code for wireless communication at a first UE, the code comprising instructions executable by a processor to perform a method of any of aspects 12 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor;
memory coupled with the processor; and
instructions stored in the memory and executable by the processor to cause the apparatus to:
receive, from a second UE, a sidelink message comprising time information indicating an absolute time value referenced to a calendar date, wherein the sidelink message is received according to a plurality of time intervals established for communication between the first UE and the second UE;
set, based at least in part on the absolute time value, an absolute time clock at a boundary of a reference time interval of the plurality of time intervals; and
communicate in accordance with the absolute time clock.

2. The apparatus of claim 1, wherein the instructions are further executable by the processor to cause the apparatus to:
transmit, to the second UE, a request for the time information, wherein the sidelink message comprising the time information is received from the second UE in response to transmitting the request.

3. The apparatus of claim 1, wherein the boundary of the reference time interval is at a beginning of the reference time interval, the reference time interval immediately after a time interval in which the sidelink message is received.

4. The apparatus of claim 1, wherein the instructions are further executable by the processor to cause the apparatus to:
receive, in the time information of the sidelink message, an indicator of the reference time interval.

5. The apparatus of claim 4, wherein the indicator of the reference time interval comprises a distributed frame number.

6. The apparatus of claim 4, wherein the sidelink message comprises a first field comprising the absolute time value and a second field comprising the indicator of the reference time interval, and the second field comprises a third field indicating additional reference time information.

7. The apparatus of claim 4, wherein the sidelink message comprises a first field comprising the absolute time value and the indicator of the reference time interval, and the sidelink message comprises a second field indicating additional reference time information.

8. The apparatus of claim 1, wherein the time information indicates a type of the absolute time value, the type of the absolute time value corresponding to either universal time coordinated time, global positioning system time, or local clock time.

9. The apparatus of claim 1, wherein the instructions to receive the sidelink message comprising the time information are executable by the processor to cause the apparatus to:
receive, from the second UE in a broadcast or groupcast transmission, a medium access control (MAC) control element (MAC-CE) comprising the time information.

10. The apparatus of claim 1, wherein the instructions are further executable by the processor to cause the apparatus to:
communicate with the second UE or a third UE for timing synchronization, wherein the reference time interval comprises a frame with boundaries determined based at least in part on communicating with the second UE or the third UE for timing synchronization.

11. The apparatus of claim 1, wherein the first UE is outside a coverage area of any network entity, and the second UE is within a coverage area of at least one network entity.

12. An apparatus for wireless communication at a first user equipment (UE), comprising:
a processor;
memory coupled with the processor; and
instructions stored in the memory and executable by the processor to cause the apparatus to:
receive a message comprising first time information indicating a first absolute time value, wherein the first absolute time value is reference to a calendar date;
set an absolute time clock at a first boundary of a first reference time interval based at least in part on the first absolute time value;
determine a second absolute time value at a second boundary of a second reference time interval based at least in part on the absolute time clock, wherein the second reference time interval is one of a plurality of time intervals established for communication between the first UE and a second UE; and
transmit, to the second UE, a sidelink message comprising second time information indicating the second absolute time value.

13. The apparatus of claim 12, wherein the instructions are further executable by the processor to cause the apparatus to:
receive, from the second UE, a request for the second time information, wherein the sidelink message comprising the second time information is transmitted to the second UE in response to receiving the request.

14. The apparatus of claim 12, wherein the instructions to receive the message comprising the first time information are executable by the processor to cause the apparatus to:
receive, from a network entity, a downlink message comprising the first time information indicating the first absolute time value.

15. The apparatus of claim 14, wherein the first reference time interval is indicated by a system frame number in the first time information.

16. The apparatus of claim 12, wherein the instructions to receive the message comprising the first time information are executable by the processor to cause the apparatus to:
receive, from a third UE, a second sidelink message comprising the first time information indicating the first absolute time value.

17. The apparatus of claim 16, wherein the first reference time interval is indicated by a distributed frame number in the first time information.

18. The apparatus of claim 12, wherein the second boundary of the second reference time interval is at a beginning of the second reference time interval, the second reference time interval immediately after a time interval in which the sidelink message is transmitted.

19. The apparatus of claim 12, wherein the instructions are further executable by the processor to cause the apparatus to:
transmit, in the second time information of the sidelink message, an indicator of the second reference time interval.

20. The apparatus of claim 19, wherein the indicator of the second reference time interval comprises a distributed frame number.

21. The apparatus of claim 19, wherein the sidelink message comprises a first field comprising the second absolute time value and a second field comprising the indicator of the second reference time interval, and the second field comprises a third field indicating additional reference time information.

22. The apparatus of claim 19, wherein first sidelink message comprises a first field comprising the second absolute time value and the indicator of the second reference time interval, and the sidelink message comprises a second field indicating additional reference time information.

23. The apparatus of claim 12, wherein the second time information indicates a type of the second absolute time value, the type of the second absolute time value corresponding to either universal time coordinated time, global positioning system time, or local clock time.

24. The apparatus of claim 12, wherein the instructions to transmit the sidelink message comprising the second time information are executable by the processor to cause the apparatus to:
transmit, in a broadcast or groupcast transmission, a medium access control (MAC) control element (MAC-CE) comprising the second time information.

25. The apparatus of claim 12, wherein the instructions are further executable by the processor to cause the apparatus to:
communicate with a third UE or a network entity for timing synchronization, wherein boundaries for the first reference time interval and the second reference time interval are determined based on communicating with the third UE or the network entity for timing synchronization.

26. The apparatus of claim 12, wherein the first UE is within a coverage area of at least one network entity, and the second UE is outside a coverage area of any network entity.

27. A method for wireless communication at a first user equipment (UE), comprising:
receiving, from a second UE, a sidelink message comprising time information indicating an absolute time value referenced to a calendar date, wherein the sidelink message is received according to a plurality of time intervals established for communication between the first UE and the second UE;
setting, based at least in part on the absolute time value, an absolute time clock at a boundary of a reference time interval of the plurality of time intervals; and
communicating in accordance with the absolute time clock.

28. The method of claim 27, further comprising:
transmitting, to the second UE, a request for the time information, wherein the sidelink message comprising the time information is received from the second UE in response to transmitting the request.

29. A method for wireless communication at a first user equipment (UE), comprising:
receiving a message comprising first time information indicating a first absolute time value, wherein the first absolute time value is reference to a calendar date;
setting an absolute time clock at a first boundary of a first reference time interval based at least in part on the first absolute time value;
determining a second absolute time value at a second boundary of a second reference time interval based at least in part on the absolute time clock, wherein the second reference time interval is one of a plurality of time intervals established for communication between the first UE and a second UE; and
transmitting, to the second UE, a sidelink message comprising second time information indicating the second absolute time value.

30. The method of claim 29, further comprising:
receiving, from the second UE, a request for the second time information, wherein the sidelink message comprising the second time information is transmitted to the second UE in response to receiving the request.
